(19) United States
(12) Patent Application Publication
(10) Pub. No.: US 2002/0121789 A1
(43) Pub. Date: Sep. 5, 2002

(54) Holding power acquisition device for an insertion device

(76) Inventors: Rainer Duebel, Baldham (DE); Stefan Friesenhan, Luttenwang (DE); Michael Winkens, Muenchen (DE)

Correspondence Address: HARNESS, DICKEY & PIERCE, P.L.C., P.O.BOX 8910, RESTON, VA, 20195, US

(21) Appl. No.: 10/084,996

(22) Filed: Mar. 1, 2002

(30) Foreign Application Priority Data
Mar. 2, 2001 (DE) 10110266.6

(51) Int. Cl. B25J 15/06; B25J 19/02

(52) U.S. Cl. 294/64.1; 294/907

(57) ABSTRACT

A placement force sensor for pick-and-place devices for picking and placing components onto substrates includes a component gripper arranged on a holder. A force sensor is further arranged between the holder and the component gripper), so that the placement force with which the component is placed onto the substrate can be sensed directly by the force sensor. Very small moving masses achieve high measuring accuracy and reliability of the placement force sensor. The provision of a spring in the flux of force between the component gripper and the holder allows the accuracy to be increased even further.

The present application hereby claims priority under 35 U.S.C. §119 on German patent publication number DE 10110266.6 filed Mar. 2, 2001, the entire contents of which are hereby incorporated by reference.

### FIELD OF THE INVENTION

The invention generally relates to a placement force sensor for pick-and-place devices for picking and placing components onto substrates.

When picking and placing components onto substrates via automatic pick-and-place machines which have pick-and-place devices, there is the problem that the components are to be placed onto the substrate with a predetermined force. Otherwise, there is the risk of damaging the components and/or the substrate. The strong trend toward ever greater miniaturization of the components indicates that ever greater accuracy is required in the predetermination of the placement force of the components onto the substrates.

### BACKGROUND OF THE INVENTION

In the past it was attempted, for example as provided by DE 19612391, to spring-mount a component gripper, via which the components can be picked up from a container and deposited on a substrate, with respect to a holder, on which the component gripper is held. For this purpose, a spring with a linear spring constant was used. By fixing the spring excursion, it was possible to fix a specific placement force for the component onto the substrate.

It has also been attempted, for example as provided by U.S. Pat. No. 5,420,488, to arrange an inductive or capacitive displacement measuring system between a housing, a pick-and-place device and a holder for a component gripper, and to spring-mount the holder in relation to the housing in the picking and placing direction. In this case, it is possible by evaluating the displacement information supplied by the capacitive or inductive displacement measuring system together with the information on the spring constant of the spring, via which the holder is mounted in relation to the housing of the pick-and-place device, to determine the force via which the component is placed onto the substrate.

However, the known proposals have the disadvantage that the movable part of the measuring system, via which the placement force can be ascertained, has very great masses, which falsify the measurement result and lead to high loading of the components. This is attributable to the fact that the measuring system for sensing the placement force is at a great distance from the point at which the component is to be picked and placed, as a result of which many components are involved in the measurement of the placement force, or have to be moved for measuring the placement force. The great moved masses and the large number of components involved, such as for example pressure lines, cables etc., also give rise to vibration problems, which reduce the accuracy by means of which the placement force can be sensed.

### SUMMARY OF THE INVENTION

An embodiment of the invention is based on an object of specifying a placement force sensor, with which the placement force of a component onto a substrate can be specified, more reliably and more accurately.

An object according to an embodiment of the invention can be achieved by a placement force sensor.

An embodiment of the invention provides a placement force sensor for pick-and-place devices for picking and placing components onto substrates which includes a holder; a component gripper, held by the holder, for gripping the components; and a force sensor, coupled with the holder and the component gripper, for measuring forces which act on the component gripper in a picking and placing direction.

According to an embodiment of the invention, the force sensor can be arranged between the holder and the component gripper. As a result, forces in the picking and placing direction can be sensed by the force sensor without disturbing vibrations. What is more, only the component gripper may be moved in relation to the force sensor during the sensing of the placement force of the component onto the substrate.

Consequently, according to an embodiment of the invention, the masses which have to be moved in the picking and placing direction for measuring the placement force may be very small.

The component gripper may be held on the holder in such a way that it can be moved in the picking and placing direction, and a spring which is coupled to the force sensor and includes a progressive spring constant may be arranged between the holder and the component gripper, before or after the force sensor in the picking and placing direction. Provision of the spring on the force sensor and movable holding of the component gripper on the holder make it possible to set very different placement forces for different components onto the substrates with small spring excursions.

In this case, the component gripper arranged on the holder can be moved toward the substrate, for example via a drive coupled with the holder, until it has been sensed by the force sensor that the predetermined placement force has been achieved. The drive is switched off in response to the sensing of the predetermined force by the force sensor. The component gripper may, for example, be held on the holder directly by the spring and the force sensor. In this case, additional guidance of the component gripper on the holder is not required. Disturbances of the measurement result of the placement force sensor, for example due to bearing forces of a mounting of the component gripper on the holder, do not occur.

The holder may also have a suction channel for directing a vacuum to the component gripper. This makes it possible to use a vacuum pipette as the component gripper. Vacuum pipettes of this type can be made very lightweight, as a result of which the masses to be moved in the measurement of the placement force are very small. This achieves the effect of great measurement accuracy. Damage to components caused by large moving masses and their mass inertia is also avoided.

The component gripper may be detachably arranged on the holder. This achieves the effect that the suitable component gripper can be respectively used for different components.

The force sensor may be a strain gage and/or a piezoceramic force sensor, for example. With sensors of this type, the placement force can be sensed directly as a voltage present at the piezoceramic force sensor or as a change in resistance of the strain gage. The spring constant does not have to be taken into account in this case for the sensing of the force, since the placement force is converted by the force sensor directly into an electrical measured variable corresponding to the force.

The spring may, for example, have an elastomeric material. Furthermore, the holder may be of a hollow-cylindrical form, the component gripper may be a vacuum pipette, and the force sensor and the spring may in each case be of an annular form. For example, the spring has a cross section tapering toward the component gripper.

The component gripper may, for example, be able to be fitted onto the hollow-cylindrical holder or onto the force sensor or the spring. This makes possible a compact arrangement of the placement force sensor with small masses to be moved for the determination of the placement force.

### BRIEF DESCRIPTION OF THE DRAWINGS

The invention is explained in more detail with reference to the preferred embodiments and to the drawing, in which:

FIG. 1 shows a section of a preferred embodiment of the invention.

### DETAILED DESCRIPTION OF THE PREFERRED EMBODIMENTS

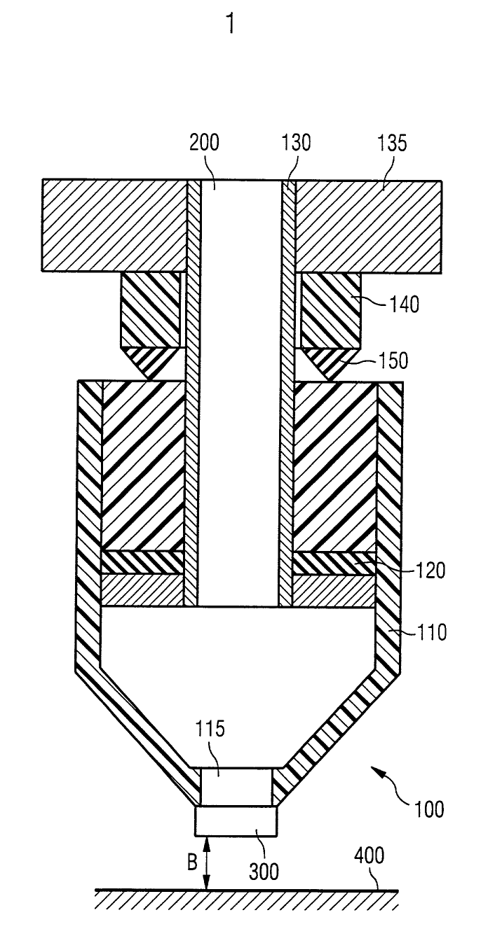

A preferred embodiment of the invention can be seen from FIG. 1. A placement force sensor 100 includes a component gripper 110 in the form of a vacuum pipette. At its end facing the substrate 400, the vacuum pipette 110 is provided with an opening 115. If a vacuum is applied to the vacuum pipette 110, a component 300 can be sucked onto the opening 115 and held on it by vacuum. The vacuum pipette 110 is arranged on a holder 130. For example, it can be fitted onto the holder and fastened on the holder 130 via a sealing ring 120, which also serves as a damping material.

The holder 130 is provided with a suction channel 200. The holder 130 is of a hollow-cylindrical form and the suction channel 200 leads through the hollow cylinder.

Also provided on the holder 130 is a stop 135. The stop 135 is formed, for example, as an annular stop, which projects radially from the hollow-cylindrical holder 130. Provided on the surface of the stop 135 facing the vacuum pipette 110 is a force sensor 140, for example in the form of an annular piezoceramic force pickup. Attached to the force sensor 140 is a spring 150, which is, for example, an annular elastomer or rubber spring which has a triangular cross section which tapers toward the vacuum pipette 110.

The vacuum pipette 110 is arranged on the holder 130 in such a way that it is displaceable in relation to the holder 130 in the picking and placing direction B, in the figure the direction perpendicular in relation to the substrate. For picking and placing the component 300, the holder 130 is displaceable in the picking and placing direction, so that the vacuum pipette is movable in the picking and placing direction B in relation to the substrate 400. By moving the vacuum pipette to different extents when placing the component 300 onto the substrate 400 in the picking and placing direction B, i.e. by compressing the spring 150 to different extents, it is possible to provide placement forces of different magnitudes for different components 300.

The spring constant of the spring 150 may, for example, have a progressive characteristic, to create a large spectrum for possible placement forces with a relatively small overall spring excursion.

According to an embodiment of the invention, the sensing of the placement force by the force sensor 140 is not dependent on the spring constant of the spring 150, since the force sensor 140 is arranged in the flux of force of the placement force in the picking and placing direction. This makes possible a direct measurement of the placement force by the force sensor 140. The arrangement according to an embodiment of the invention of the force sensor 140 in the flux of force of the placement force of the component 300 onto the substrate 400 achieves the effect that both very small placement forces and very large placement forces can be sensed more precisely, since the mass to be moved in the measurement, the vacuum pipette 110, is very small.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A placement force sensor for pick-and-place devices for picking and placing components onto substrates comprising:
a holder;
a component gripper, held on the holder, for gripping the components; and
a force sensor, coupled with the holder and the component gripper, for measuring forces which act on the component gripper in a picking and placing direction, wherein the force sensor is arranged between the holder and the component gripper, and wherein forces in the picking and placing direction are senseable by the force sensor.

2. The placement force sensor as claimed in claim 1, wherein, the component gripper is held on the holder such that it can be moved in the picking and placing direction, and the sensor further comprising:
a spring, which is coupled to the force sensor and having a progressive spring constant, arranged between the holder and the component gripper, before the force sensor in the picking and placing direction.

3. The placement force sensor as claimed in claim 1, wherein, the component gripper is held on the holder such that it can be moved in the picking and placing direction, and the sensor further comprising:
a spring, which is coupled to the force sensor and having a progressive spring constant, arranged between the holder and the component gripper, after the force sensor in the picking and placing direction.

4. The placement force sensor as claimed in claim 1, wherein the holder is movable in the picking and placing direction via a drive, and wherein the drive can be switched off in response to the sensing of a predetermined force by the force sensor.

5. The placement force sensor as claimed in claim 2, wherein the holder is movable in the picking and placing direction via a drive, and wherein the drive can be switched off in response to the sensing of a predetermined force by the force sensor.

6. The placement force sensor as claimed in claim 3, wherein the holder is movable in the picking and placing direction via a drive, and wherein the drive can be switched off in response to the sensing of a predetermined force by the force sensor.

7. The placement force sensor as claimed in claim 2, wherein, the component gripper is held on the holder by the spring and the force sensor.

8. The placement force sensor as claimed in claim 3, wherein, the component gripper is held on the holder by the spring and the force sensor.

9. The placement force sensor as claimed in claim 1, wherein the holder includes a suction channel for directing a vacuum to the component gripper.

10. The placement force sensor as claimed in claim 1, wherein the component gripper is detachably arranged on the holder.

11. The placement force sensor as claimed in claim 1, wherein the force sensor includes at least one of a strain gage and a piezoceramic force sensor.

12. The placement force sensor as claimed in claim 2, wherein the spring includes an elastomeric material.

13. The placement force sensor as claimed in claim 3, wherein the spring includes an elastomeric material.

14. The placement force sensor as claimed in claim 2, wherein the holder is of a hollow-cylindrical form, the force sensor is of an annular form, and the spring is of an annular form with a cross section tapering toward the component gripper.

15. The placement force sensor as claimed in claim 3, wherein the holder is of a hollow-cylindrical form, the force sensor is of an annular form, and the spring is of an annular form with a cross section tapering toward the component gripper.

16. A pick and place device including the placement force sensor of claim 1.

17. A pick and place device including the placement force sensor of claim 2.

18. A pick and place device including the placement force sensor of claim 3.

19. The placement force sensor as claimed in claim 2, wherein the force sensor includes at least one of a strain gage and a piezoceramic force sensor.

20. The placement force sensor as claimed in claim 3, wherein the force sensor includes at least one of a strain gage and a piezoceramic force sensor.
